(19) United States
(12) Patent Application Publication
(10) Pub. No.: US 2009/0049203 A1
(43) Pub. Date: Feb. 19, 2009

(54) Communication layer switching device

(76) Inventors: Itay Sherman, Hod Hasharon (IL); Eyal Bychkov, Hod Hasharon (IL); Uri Ron, Tel Aviv (IL)

Correspondence Address: Soquel Group, LLC, P.O. Box 691, Soquel, CA, 95073, US

(21) Appl. No.: 11/893,958

(22) Filed: Aug. 16, 2007

(51) Int. Cl. G06F 15/16

(52) U.S. Cl. 709/250

(57) ABSTRACT

A switchable communicator, including a processor for running at least one communication service, up to at least communication layer 2, in conjunction with a computer to which the communicator is docked, a memory coupled with the processor for storing program code and data for the at least one communication service, a modem coupled with the processor for transmitting and receiving data for the at least one communication service, an input device coupled with the processor for inputting data to be transmitted by the at least one communication service, an output device coupled with the processor for displaying data that is received by the at least one communication service, and an interface for docking the communicator to the computer, and for synchronizing communication service data between the communicator and the computer when the communicator is docked to the computer, wherein the computer may be in an active mode or in an inactive mode, and wherein the processor switches to run the at least one communication service by itself, up to communication layer 7, when the computer is in inactive mode. A method is also described and claimed.

### FIELD OF THE INVENTION

The field of the present invention is modems and communication applications.

### BACKGROUND OF THE INVENTION

Personal computers (PCs) use external communication interfaces, such as cellular modems, wireless LANs, Bluetooth and Ethernet, to provide communication applications such as web browsing, e-mail, instant messaging, calendar scheduler, voice over IP and video conferencing. In addition, some consumer electronic (CE) computing devices, such as game stations, PDAs and portable music players also use external communication interfaces to provide communication applications. The PC/CE computer controls the communication modem and communicates therewith.

The standard TCP/IP communication protocol includes 7 communication layers. Implementation of these layers is divided between the computer and the modem. Modems generally implement communication layers 1 and 2. If a modem includes router functionality, then it may also implement communication layer 3. The higher communication layers are implemented by the PC/CE computer.

When a PC/CE computer goes into a low power mode, such as sleep mode or hibernation mode, the internal processor of the PC/CE computer is halted, and communication links established via the modem are severed. This happens even when the modem derives its power from an external power source. Thus, the modem itself may not be in low power mode, but nevertheless communication is severed because the host PC/CE is in low power mode.

Since PCs and, even more so, mobile CE computing devices, frequently switch to low power modes of operation in order to preserve power, the availability of their communication services is limited. This is particularly disadvantageous for services that have real time behavior, such as e-mail and calendar services for which outside data is continuously being sent.

It would thus be advantageous to be able to maintain communication services such as e-mail even when a computer is in an inactive power mode.

One solution to avoiding loss of communication when a computer is shut down is provided by the Active Notifications technology developed by Microsoft Corporation of Redmond, Wash. Active Notification uses the Windows SideShow™ technology, also developed by Microsoft Corporation, to show notifications for e-mail messages and calendar reminders on compatible secondary display devices, when a PC is in sleep mode.

SideShow uses mini-programs, also referred to as “gadgets”, to enable various compatible devices connected to a computer to run using data from the computer, whether the computer is turned on, turned off, or in a sleep power state. The mini-programs run on the computer, and update the devices with data from the computer. However, on-line communication is only done via the computer, and not via the connected devices.

Active Notification provides two modes of notification, as follows.

An immediate notification and synchronization mode keeps a mobile computer continually connected to a Microsoft Exchange server, even when the PC is asleep. This mode of notification is only available for PCs that have wireless WAN modems and wireless data service. In this mode, the wireless WAN modem monitors a network for an e-mail signal from the Exchange server, and wakes up the PC, as necessary, for automatic synchronization. After synchronization the PC resumes its sleep mode. Alternatively, in a notification-only mode, synchronization is not performed unless directed by the user; i.e., the user decides when to wake up the PC and perform synchronization.

A periodic notification and synchronization mode enables the user to determine how often the PC is awoken and synchronized with the Exchange server.

However, in both of the above modes of notification, the PC must be turned on in order to be synchronized with the Exchange server.

It should be advantageous to overcome this limitation as well, and provide a solution that maintains communication services when a computer is asleep, without having to wake up the computer and bring it back into active mode.

### SUMMARY OF THE DESCRIPTION

The present invention overcomes loss of communication services, such as e-mail service and instant messaging service, when computers switch to inactive power modes. Aspects of the present invention provide a switchable communication device, referred to as a switchable communicator, that provides normal modem functionality when operating in conjunction with a computer that is in an active power mode, and that seamlessly switches to take over communication services from the computer when the computer switches to inactive power mode. While the computer is in active power mode, the switchable communicator implements low communication layers in conjunction with the computer that implements the higher communication layers. However, when the computer is in inactive power mode, the switchable communicator implements all communication layers, thereby maintaining communication services while the computer is inactive.

The communicator synchronizes communication service data with the computer as appropriate prior to the computer entering inactive power mode, and subsequent to the computer resuming active power mode. For e-mail service, login information and mail server address are synchronized between the computer and the communicator. In addition, for e-mail policies that enable manipulation of e-mail messages off of the e-mail server, downloaded e-mail messages are also synchronized. Optionally, a list of contacts and a calendar schedule are also synchronized.

For instant messaging service, login information and a list of contacts are synchronized between the computer and the communicator. Optionally, message discussion histories are also synchronized.

Communication services being implemented by the communicator alone may have some limited functionality. For example, e-mail messages may be processed for headers and text, but not for attachments and pictures. Similarly, instant messages may be processed for simple text, but not for graphical and audible icons, referred to variously as emoticons and winks.

There is thus provided in accordance with an embodiment of the present invention a switchable communicator, including a processor for running at least one communication service, up to at least communication layer 2, in conjunction with a computer to which the communicator is docked, a memory coupled with the processor for storing program code and data for the at least one communication service, a modem coupled with the processor for transmitting and receiving data for the at least one communication service, an input device coupled with the processor for inputting data to be transmitted by the at least one communication service, an output device coupled with the processor for displaying data that is received by the at least one communication service, and an interface for docking the communicator to the computer, and for synchronizing communication service data between the communicator and the computer when the communicator is docked to the computer, wherein the computer may be in an active mode or in an inactive mode, and wherein the processor switches to run the at least one communication service by itself, up to communication layer 7, when the computer is in inactive mode.

There is moreover provided in accordance with an embodiment of the present invention a method for switchable communication, including synchronizing data for at least one communication service from a computer to a communicator, prior to the computer switching to a low power mode of operation, running the at least one communication service on the communicator while the computer is in the low power mode of operation, whereby the communicator manages communication layers up to layer 7, synchronizing data for the at least one communication service from the communicator to the computer when the computer is switched back to a full power mode of operation, and running the at least one communication service on the computer in conjunction with the communicator while the computer is in the full power mode of operation, whereby the communicator managers low communication layers up to at least layer 2 and the computer manages the higher communication layers.

### BRIEF DESCRIPTION OF THE DRAWINGS

The present invention will be more fully understood and appreciated from the following detailed description, taken in conjunction with the drawings in which:

FIG. 1 is a simplified block diagram of a switchable communicator, in accordance with an embodiment of the present invention;

FIG. 2 is a picture of a physical switchable communicator, in accordance with an embodiment of the present invention;

FIG. 3 is a simplified block diagram of a network of switchable communicators, in accordance with an embodiment of the present invention; and

FIG. 4 is a simplified flowchart of operation of a switchable communicator, in accordance with an embodiment of the present invention.

### DETAILED DESCRIPTION

Aspects of the present invention relate to methods and systems for seamlessly switching over from a computer to a modem, to maintain communication services such as e-mail, calendar scheduling and instant messaging, when the computer enters a low power inactive mode. Although the computer's processor is turned off, the modem, running on its own power source, is able to maintain communication services. Communication service data is synchronized from the computer to the modem prior to the computer entering the low power inactive mode, and from the modem to the computer subsequent to the computer resuming a full power active mode. Thus the communication service is handed down from the computer to the modem while the computer is asleep, and handed back from the modem to the computer when the computer is aware, without data discrepancy.

It will be appreciated by those skilled in the art that power management of the modem enables the modem to have standby time lasting for hundreds of hours. Moreover, whereas computers are often switched to low power modes, the modem is active all the time, 24 hours per day, 7 days per week. As such, using the modem for online communication services in accordance with the present invention is very advantageous.

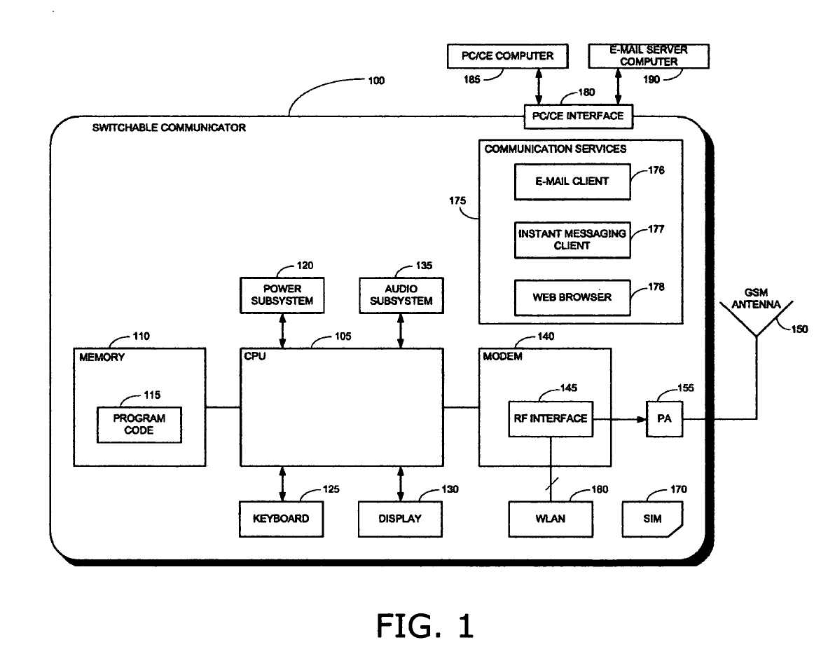

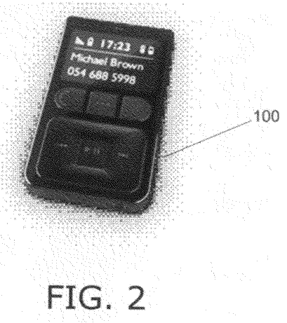

Reference is now made to FIG. 1, which is a simplified block diagram of a switchable communicator 100, in accordance with an embodiment of the present invention. Reference is also made to FIG. 2, which is a picture of the physical switchable communicator 100, in accordance with an embodiment of the present invention. Communicator 100 generally has a USB connector, an SD connecter, or a wireless Bluetooth connector, or a combination of two or more such connectors.

As shown in FIG. 1, switchable communicator 100 includes a central processing unit 105, and a memory 110 that has program code 115 stored therewithin. Switchable communicator 100 has its own power subsystem 120. Switchable communicator 100 has input and output peripherals, including inter alia a keyboard 125 for input and a display 130 for output. Switchable communicator 100 further includes an audio subsystem 135 for playing music.

For data transmission, switchable communicator 100 includes a modem 140 with an RF interface 145 therewithin. Modem 140 transmits and receives voice signals using a GSM antenna 150, coupled with a power amplifier 155. Modem 140 transmits and receives digital data using wireless transmission, including inter alia wireless LAN 160.

Switchable communicator 100 also includes a SIM card 170 for storing data such as configuration data and a list of contacts.

In accordance with an embodiment of the present invention, switchable communicator 100 supports one or more communication services 175, such as an e-mail client 176, an instant messaging client 177 and a web browser 178, up to communication layer 7. Switchable communicator 100 also supports standard communication modem functionality at communication layers 2 or 3.

Switchable communicator 100 includes a PC/CE interface 180, for connection to a PC or to a CE computing device 185. PC/CE interface 175 enables communicator 100 to communicate with PC/CE computer 185, and also to determine the power state of PC/CE computer 185. A power state may be inter alia a full-power active mode, and a low-power mode such as sleep mode and hibernation mode. Switchable communicator 100 may be physically docked with PC/CE computer 185, and electronically connected via a USB, SD or such other connector. Alternatively, switchable communicator 100 may be connected to PC/CE computer 185 via a wireless connector, such as a Bluetooth connector. Communicator 100 changes its mode of operation, based on the power state of PC/CE computer 185 that it is docked with, as described hereinbelow.

When communicator 100 is docked with PC/CE computer 185, and PC/CE computer 185 is in active power mode, then communicator 100 operates as a standard communication modem, implementing the lower communication layers, up to layers 2 or 3. Communicator 100 forwards data to and receives data from PC/CE computer 185 at the lower communication layers, via interface 175. PC/CE computer 185 implements the high communication layers, including applications for various communication services, such as e-mail and chat.

While PC/CE computer 185 is active, it updates service applications on communicator 100 with requisite parameters, for communication services 175 supported by communicator 100. For example, the PC/CE computer updates e-mail client 176 with parameters including an address for an e-mall server 190 and login information. In addition, PC/CE computer 185 may update e-mail client 176 with downloaded e-mails, as per the mail server download policy. Such updating by PC/CE computer 185 for e-mail client 176 may be performed in real-time, or periodically, or prior to PC/CE computer 185 transitioning to a low-power mode.

While PC/CE computer 185 is inactive, in a low-power mode such as sleep mode or hibernation mode, communicator 100 uses its own internal service applications, thereby allowing communication services 175 to be maintained throughout the period of inactivity for PC/CE computer 185. Some or all of communication services 175 may have limited display and processing functionalities vis a vis those of PC/CE computer 185. For example, e-mail client 176 may be able to extract incoming e-mail from e-mail server 190, but may not be able to process or display e-mail attachments. I.e., e-mail client 176 may be able to display e-mail headers and text, but not be able to process or display attachments. When PC/CE computer 185 returns to active mode, communicator 100 provides PC/CE computer 185 with requisite parameters to resume its own services, which communicator 100 operated during PC/CE computer's 185 period of inactivity.

What follows is a discussion of e-mail client 176, and the synchronization that seamlessly enables communication e-mail client 176 to take over e-mail service from PC/CE computer 185, when PC/CE computer 185 is inactive, and hand back the e-mail service to PC/CE computer 185 when PC/CE computer 185 resumes its activity.

E-Mail Synchronization between Communicator 100 and PC/CE Computer 185

POP3 and IMAP4 are two commonly used protocols for receiving e-mail, and SMTP is a commonly used protocol for sending e-mail. POP3 supports end-users with sporadic network connections, such as dial-up connections, enabling the users to retrieve e-mail messages when connected, and then to view and manipulate the retrieved message without remaining connected. IMAP supports both connected and disconnected modes of operation. E-mail clients using IMAP generally leave messages on the e-mail server until a user expressly deletes them.

Regardless of which protocol is used, e-mail client 176 connects to e-mall server 190 via any of the supported network access methods, including inter alia WLAN, GPRS and GSM dial-up. Such network access is secured using cryptographic protocols, including inter alia Secure Socket Layer (SSL) and Transport Layer Security (TLS), as supported by e-mail client 176 and e-mail server 190. Using WLAN as an example, when communicator 100 connects to e-mail server 190, several parameters must be pre-configured, as follows.
Service Set Identifier (SSID)—a unique network name including up to 32 characters;
Security type—none, WEP, WPA, WPA2, or such other type
Security password—an alphanumeric string
Network type—ad-hoc wireless network (IBSS), or infrastructure networks which includes an access point (BSS or possible an ESS)

After connection, the information exchanged between communicator 100 and e-mail server 190 generally depends on the type of e-mail download policy. If, as per the IMAP protocol, a user stores his e-mails on e-mail server 190 and does not download them to PC/CE computer 185, then when PC/CE computer 185 is inactive, e-mail client 185 accesses the user's e-mails from e-mail server 190. As such, when PC/CE computer 185 resumes activity, the user can continue accessing his e-mails from e-mail server 190, without requiring special synchronization. Only basic synchronization is required, such as synchronization of login information prior to PC/CE computer 185 transitioning to off-line mode. For example, if the user changed his password, then the new password is transferred to communicator 100.

However, if the user manages his e-mails locally on PC/CE computer 185, instead of on e-mail server 190, then special synchronization is required. Specifically, prior to PC/CE computer 185 shutting down, synchronization from PC/CE→communicator occurs by transferring new and changed contacts, and new and changed e-mail messages, and changed login information including inter alia server name, user name, domain name, e-mail address and password.

According to one embodiment of the present invention, only e-mail headers and plain text messages are transferred to communicator 100, as well as text-only contact details, without attachments and without images. Subsequently, when PC/CE computer 185 is in low-power mode, access to the user's e-mail account is conducted via e-mail client 176. E-mail client 176 only downloads e-mail headers and plain text messages. E-mail client is operable to send text e-mails, and to create and change contact information. When PC/CE computer 185 resumes its activity, synchronization from communicator→PC/CE occurs, updating PC/CE computer 185 with relevant changes. The ActiveSync® software application, manufactured by Microsoft Corporation of Redmond, Wash., may be used for such synchronization in conjunction with Microsoft's Windows operating system.

The connection between communicator 100 and e-mail server computer 190, or such other server computer may be any wireless connection, and is not limited to GSM. Use of GSM in FIG. 1 and the discussion thereof is for the sake of clarity, and not intended to be limiting.

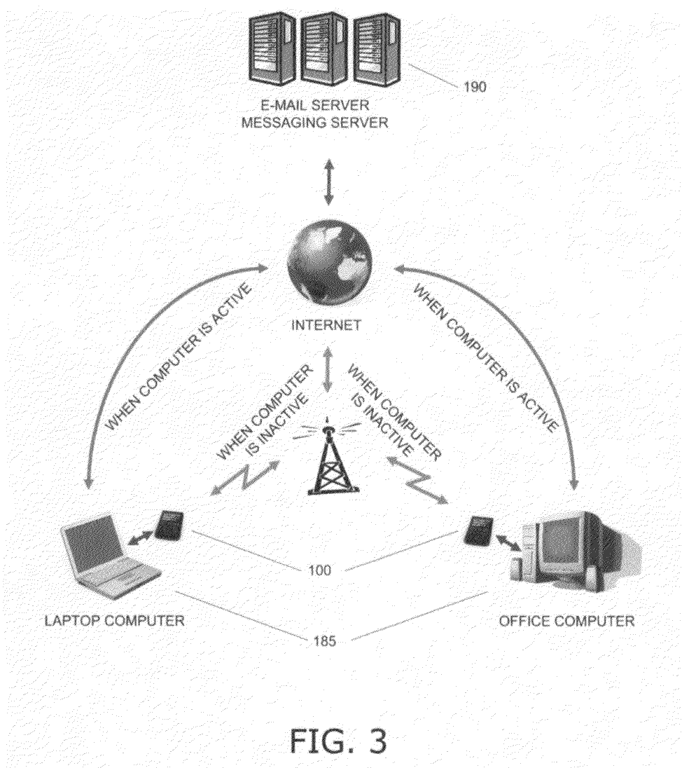

Reference is now made to FIG. 3, which is a simplified block diagram of a network of switchable communicators, in accordance with an embodiment of the present invention. Shown in FIG. 3 are laptop and office computers 185, connected to corresponding switchable communicators 100. When computers 185 are active, communicators 100 operate as modems in conjunction with computers 185. Computers 185 receive and send e-mails and messages via server 190, which provides communication services, include an e-mail service and a messaging service. When computers 185 are active, the communication services are directed to computers 185. However, when computers 185 are inactive, the communication services are directed instead to switchable communicators 100.

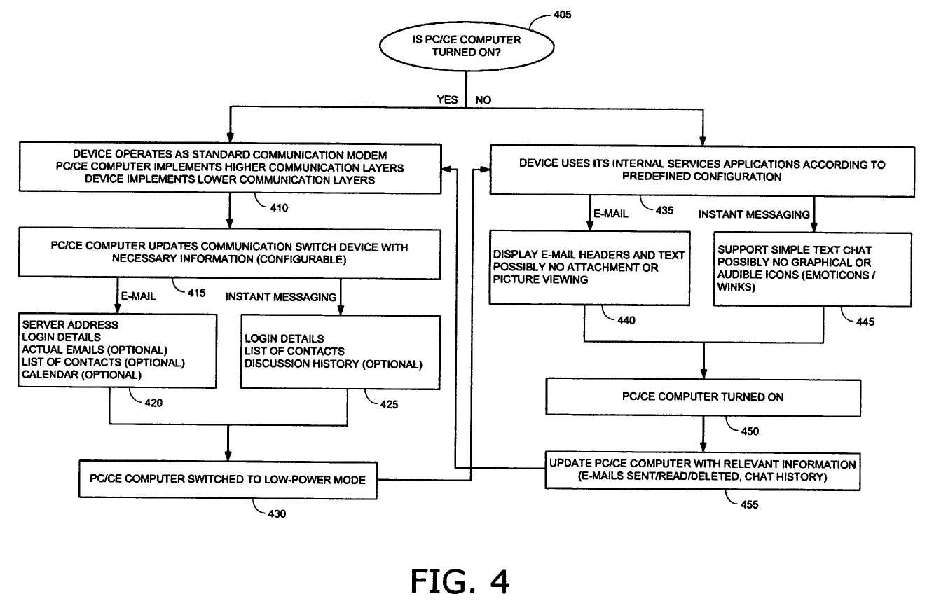

Reference is now made to FIG. 4, which is a simplified flowchart of operation of switchable communicator 100, in accordance with an embodiment of the present invention. At step 405 a determination is made whether or not PC/CE computer 185 is turned on. If so, then at step 410 communicator 100 operates as a standard communication modem: PC/CE computer 185 implements the higher communication layers, and communicator 100 implements the lower communication layers.

At step 415 synchronization from PC/CE→communicator occurs. PC/CE computer 185 updates communicator 100 with requisite information for communication services 175. The designation of which information is to be updated at step 415 is configurable. For e-mail client 176, updated information includes an address for e-mail server 190, login information and, optionally dependent upon e-mail policy as described hereinabove, actual e-mail messages, list of contacts and calendar information, as indicated at step 420. For instant messaging client 177, updated information includes login information, list of contact and, optionally a discussion history, as indicated at step 425.

At step 430, PC/CE computer 185 is switched from active mode to a low-power mode, such as a sleep or a hibernation mode, and the method advance to step 435.

Referring back to step 405, if it is determined that PC/CE computer 185 is turned off, then at step 435 communicator 100 operates communication services 175, based on pre-defined configurations. Communication services 175 may have limited functionalities when operated entirely by communicator 100. E-mail client 176, for example, may enable display of e-mail headers and text, but may not enable attachment and picture viewing, as indicated at step 440. Instant messaging client 177, for example, may support simple text chat, but may not support graphical or audible icons, referred to variously as “emoticons” and “winks”, as indicated at step 445.

At step 450, PC/CE computer 185 is turned on. At step 455 synchronization from communicator→PC/CE occurs. Communicator 100 updates PC/CE computer 185 with relevant information in order that PC/CE computer 185 can seamlessly take over the communication services from communicator 100. The method then proceeds to step 410.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A switchable communicator, comprising:
a processor for running at least one communication service, up to at least communication layer 2, in conjunction with a computer to which the communicator is docked;
a memory coupled with said processor for storing program code and data for the at least one communication service;
a modem coupled with said processor for transmitting and receiving data for the at least one communication service;
an input device coupled with said processor for inputting data to be transmitted by the at least one communication service;
an output device coupled with said processor for displaying data that is received by the at least one communication service; and
an interface for docking the communicator to the computer, and for synchronizing communication service data between the communicator and the computer when the communicator is docked to the computer, wherein the computer may be in an active mode or in an inactive mode, and wherein said processor switches to run the at least one communication service by itself, up to communication layer 7, when the computer is in inactive mode.

2. The switchable communicator of claim 1 wherein said processor uses said interface to synchronize communication service data from the computer to the communicator prior to the computer switching to the inactive mode, and to synchronize communication service data from the communicator to the computer subsequent to the computer switching to the active mode.

3. The switchable communicator of claim 2 wherein the at least one communication service includes an e-mail client, and wherein said processor uses said interface to synchronize an e-mail server address and login information.

4. The switchable communicator of claim 3 wherein said processor uses said interface to synchronize downloaded e-mail messages.

5. The switchable communicator of claim 3 wherein said processor uses said interface to synchronize a list of contacts.

6. The switchable communicator of claim 3 wherein said processor uses said interface to synchronize a calendar schedule.

7. The switchable communicator of claim 2 wherein the at least one communication service includes an instant messaging client, and wherein said processor uses said interface to synchronize login information and a list of contacts.

8. The switchable communicator of claim 7 wherein said processor uses said interface to synchronize a discussion history.

9. The switchable communicator of claim 2 wherein the at least one communication service includes a web browser.

10. A method for switchable communication, comprising:
synchronizing data for at least one communication service from a computer to a communicator, prior to the computer switching to a low power mode of operation;
running the at least one communication service on the communicator while the computer is in the low power mode of operation, whereby the communicator manages communication layers up to layer 7;
synchronizing data for the at least one communication service from the communicator to the computer when the computer is switched back to a full power mode of operation; and
running the at least one communication service on the computer in conjunction with the communicator while the computer is in the full power mode of operation, whereby the communicator managers low communication layers up to at least layer 2 and the computer manages the higher communication layers.

11. The method of claim 10 wherein the at least one communication service includes an e-mail client, and wherein said synchronizing data from computer to communicator and said synchronizing data from communicator to computer synchronizes an e-mail server address and login information.

12. The method of claim 11 wherein said synchronizing data from computer to communicator and said synchronizing data from communicator to computer synchronizes downloaded e-mail messages.

13. The method of claim 11 wherein said synchronizing data from computer to communicator and said synchronizing data from communicator to computer synchronizes a list of contacts.

14. The method of claim 11 wherein said synchronizing data from computer to communicator and said synchronizing data from communicator to computer synchronizes a calendar schedule.

15. The method of claim 10 wherein the at least one communication service includes an instant messaging client, and wherein said synchronizing data from computer to communicator and said synchronizing data from communicator to computer synchronizes login information and a list of contacts.

16. The method of claim 15 wherein said synchronizing data from computer to communicator and said synchronizing data from communicator to computer synchronizes a discussion history.

17. The method of claim 10 wherein the at least one communication service includes a web browser.
